(19) United States
(12) Patent Application Publication
(10) Pub. No.: US 2026/0311285 A1
(43) Pub. Date: Oct. 8, 2026

(54) VIRTUAL AI-RDMA DEVICE USED TO HANDLE AI-NIC FAILURES

(71) Applicant: Advanced Micro Devices, Inc., Santa Clara, CA (US)

(72) Inventors: Krishna DODDAPANENI, Cupertino, CA (US); Raghava SIVARAMU, Santa Clara, CA (US); Sanjay THYAMAGUNDALU, Santa Clara, CA (US); Allen HUBBE, Durham, NC (US); Vipin JAIN, Santa Clara, CA (US); Sarat Babu KAMISETTY, Fremont, CA (US)

(21) Appl. No.: 19/172,139

(22) Filed: Apr. 7, 2025

(51) Int. Cl. G06T 1/20; G06T 1/60

(52) U.S. Cl. CPC G06T 1/20; G06T 1/60

(57) ABSTRACT

Embodiments herein describe a system including at least one processor, multiple network interface controllers (NICs), and a virtual remote direct memory access (RDMA) device configured to manage data workloads between processor applications and the multiple NICs when a failure event is detected in at least one NIC of the multiple NICs. The at least one processor is a graphics processing unit (GPU) and the processor applications are GPU applications. The processor applications are unaware of the failure event detected in the at least one NIC of the multiple NICs.

### TECHNICAL FIELD

Examples of the present disclosure generally relate to processors, and, in particular, to handling failures in graphics processing unit (GPU)-GPU communications.

### BACKGROUND

In data centers, the demand for high-performance computing has led to a surge in the use of graphics processing units (GPUs) for artificial intelligence (AI) and machine learning (ML) workloads. Efficient GPU-to-GPU communication is needed to maximize the performance of these workloads, particularly in distributed training and inference scenarios. Traditional data transfer approaches, relying on CPU intervention, introduce latency and reduce overall throughput. To address these limitations, recent advancements employ AI-optimized network interface cards (AI-NICs) that support direct GPU-GPU communications. AI-NICs facilitate high-speed data transport over the network fabric to reduce latency and increase data throughput.

However, the integration of AI-NICs into the communication pipeline introduces new challenges, especially in the context of reliability and fault tolerance. Failures in the AI-NIC, whether due to hardware faults, software errors, or network disruptions, can impact the performance of entire GPU clusters. Such failures may result in data packet loss, communication stalls, or degraded throughput, affecting the overall efficiency of the distributed AI workload. As such, robust mechanisms for detecting, isolating, and recovering from AI-NIC failures are needed to ensure stability and reliability of GPU-GPU communications in AI-driven environments.

### SUMMARY

One example described herein is a system including at least one processor, multiple network interface controllers (NICs), and a virtual remote direct memory access (RDMA) device configured to handle data workloads between processor applications and the multiple NICs when a failure event is detected in at least one NIC of the multiple NICs. The processor applications are unaware of the failure event detected in the at least one NIC of the multiple NICs. When the failure event is an uplink failure, the virtual RDMA device rebalances data traffic to one or more functional NICs of the multiple NICs. When the failure event is a soft failure or a hard failure, the virtual RDMA device redirects data traffic to one or more functional NICs of the multiple NICs. When the failure event results from maintenance or upgrade downtime, the virtual RDMA device rebalances data traffic to one or more functional NICs.

One example described herein is a method including electrically connecting multiple network interface controllers (NICs) within a host including at least one processor and handling data workloads between processor applications and the multiple NICs using a virtual RDMA device when a failure event is detected in at least one NIC of the multiple NICs.

One example described herein is a method including detecting a failure event in at least one network interface controller (NIC) of a plurality of NICs within a host including at least one processor and rebalancing data traffic to one or more functional NICs of the plurality of NICs using a virtual RDMA device.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a system including a host with a virtual remote direct memory access (RDMA) device for handling artificial intelligence-network interface controller (AI-NIC) failures, according to an example.

FIG. 2A illustrates detection of AI-NIC failures using the virtual RDMA device, according to an example.

FIG. 2B illustrates a cluster of graphics processing units (GPUs) communicating with the virtual RDMA device, according to an example.

FIG. 3 is a block diagram of an accelerator unit (AU) configured to execute workloads for applications running on a processing system, in accordance with some examples.

FIG. 4 is a block diagram of a data processing unit (DPU) that may be used to implement a network interface controller/card (NIC), in accordance with some examples.

FIG. 5 is a flowchart for detecting an uplink failure, in accordance with some examples.

FIG. 6 is a flowchart for detecting a soft/hard failure, in accordance with some examples.

FIG. 7 is a flowchart for detecting a software/firmware upgrade, in accordance with some examples.

FIG. 8 is a flowchart for using the virtual RDMA device to manage data workloads, in accordance with some examples.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the examples herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Graphics processing unit (GPU)-GPU communication accelerates the performance of large-scale artificial intelligence (AI) and machine learning (ML) workloads. As GPUs become the primary compute engines in data centers, the ability to efficiently transfer data between GPUs has emerged as a factor in achieving high throughput and low latency. Direct GPU-GPU communication eliminates the need for central processing unit (CPU) intervention, allowing data to flow seamlessly across multiple GPUs within the same server or across servers in a distributed cluster. This capability is beneficial in deep learning applications, where massive datasets and complex models involve frequent data exchanges between GPUs during tasks such as distributed training and inference.

Modern architectures use peripheral component interconnect express (PCIe)-based peer-to-peer (P2P) communication, and remote direct memory access (RDMA) to enable fast, low-latency GPU-GPU data transfers. These technologies reduce the overhead associated with traditional data movement methods and enable scalable parallel processing. By optimizing the communication paths between GPUs, these techniques help overcome bandwidth limitations and improve the overall computational efficiency of AI workloads.

GPU-GPU communication using RDMA is beneficial in high-performance computing (HPC) and AI infrastructure. RDMA allows data to be transferred directly between GPU memories over the network without involving the CPU or operating system kernel, thus significantly reducing latency and CPU overhead. By bypassing the traditional transmission control protocol/internet protocol (TCP/IP) stack, RDMA enables zero-copy data transfers, allowing GPUs to read and write to each other’s memory directly. Zero-copy data transfer refers to moving data between devices (e.g., GPU, RDMA, NIC, etc.) without involving the CPU or making extra memory copies. This capability is facilitated by AI-optimized network interface controllers (AI-NICs) that support RDMA protocols like RDMA over converged Ethernet (RoCE) and InfiniBand, enabling efficient data exchange across servers.

RDMA’s direct memory access eliminates the need for CPU intervention, reducing latency in data transfers. RDMA achieves high bandwidth utilization by using direct memory access and zero-copy mechanisms, allowing large data blocks to be transferred efficiently between GPUs. This maximizes the effective bandwidth of interconnects like PCIe, InfiniBand, and Ethernet. Offloading data transfer tasks to the AI-NIC frees up CPU resources, allowing CPUs to focus on other computations. RDMA enhances scalability by supporting efficient communication between multiple GPUs across different servers. This enables the construction of large GPU clusters that can handle large datasets and AI models. By minimizing data copying and reducing CPU involvement, RDMA optimizes the use of system resources, leading to better overall system performance and energy efficiency.

However, failures may be still be present in GPU-GPU communications. Failures in GPU-GPU communications can disrupt high-performance AI workloads, especially in distributed training and inference scenarios. As the reliance on direct GPU-to-GPU data transfers increases, so does the risk of encountering various failures that can degrade system performance, cause data inconsistencies, or lead to job failures. One failure type includes network interface failures. AI-NICs used for GPU-GPU communication may experience hardware faults or software bugs. These faults can result in data packet drops, errors in memory access, or loss of connectivity between GPUs. In high-bandwidth, low-latency networks, congestion can lead to packet loss. This may be an issue for protocols like RDMA that rely on reliable transport. Packet loss can trigger retransmissions, increasing latency and reducing throughput. RDMA-based communication relies on maintaining consistent connection states. Failures in RDMA connection establishment or state synchronization can disrupt the direct memory access paths between GPUs, leading to communication stalls.

In traditional network solutions, failures such as link drops, NIC hardware faults, or switch issues may result in lost connections. The standard behavior involves timeouts and disconnection errors, which are detected by the application layer. This leads to application-level errors that involve resets, retries, or rollbacks, impacting the performance and reliability of the workload. Without built-in redundancy or real-time rerouting, applications handle these failures explicitly, which may involve complex error handling logic and increased latency. Further, traditional NICs rely on the operating system and application software for error detection and recovery. When a failure occurs, it triggers error notifications to the host CPU, which then handles the recovery process. This approach introduces additional overhead and delays, as the CPU and application need to respond to the failure, resulting in stalled data transfers. The overhead from context switching, error handling, and re-establishing lost connections may cause downtime and degrade the performance of the GPU workload. Moreover, traditional RDMA implementations and network protocols lack persistent connection state management. When a failure disrupts the RDMA connection, the application resets the connection or rolls back to a previous state. This process involves discarding in-flight data, re-initializing the communication channel, and resuming transfers from a checkpoint, leading to increased latency and wasted compute cycles. In distributed AI training, such rollbacks can be costly, triggering the synchronization of all GPUs and potentially re-running parts of the computation, delaying model convergence.

Conventional RDMA systems handle such failures by relying on transport-level reliability mechanisms, hardware error detection, and network congestion management. Reliable connection (RC) and reliable datagram (RD) transport modes use acknowledgment (ACK) and retransmission techniques to ensure packet delivery, while an unreliable datagram (UD) mode lacks built-in recovery, relying on higher-level application logic for error handling. At the hardware level, RDMA NICs and host channel adapters (HCAs) implement error detection through memory protection, error checking code (ECC), and cyclic redundancy check (CRC) checking to identify and isolate faults. If a failure is detected, the affected queue pair (QP) enters an error state, and error notifications are sent to the application via the completion queue (CQ). Such traditional approaches, however, introduce latency overhead and performance degradation where retransmissions, congestion control, or failover mechanisms add delays.

To ensure high availability of the AI-NIC transport layer in GPU clusters, failure scenarios should be handled transparently without disrupting GPU application traffic. The examples present a method and system for ensuring that GPU applications remain unaffected by underlying hardware or software failures by presenting an architecture including a virtual RDMA device hosted on the AI-NIC. The virtual RDMA device is accessible to GPU applications, abstracting away the complexities of the underlying AI-NIC layer. By doing so, GPU workloads can execute uninterrupted, even when the AI-NIC encounters issues, significantly enhancing application reliability. The virtual RDMA device serves as a logical interface for GPU applications to interface with the AI-NICs, creating a consistent RDMA transport endpoint. The virtual RDMA device decouples the application layer from the physical NIC, enabling GPU applications to remain unaware of failures. This abstraction is achieved by implementing a fault-tolerant mechanism at a lower layer beneath the virtual device. The fault-tolerant mechanism monitors the health of the AI-NIC and manages failover or recovery mechanisms without exposing these events to the application layer. Such an approach ensures that data flows, buffer management, and RDMA operations continue seamlessly, irrespective of transient or permanent NIC-related issues.

To handle AI-NIC-related failures effectively, the example architecture employs strategies such as connection multiplexing, automatic failover, and state synchronization. Connection multiplexing ensures that multiple virtual paths exist between the GPU and remote devices, allowing traffic to be rerouted dynamically in case of a failure. Automatic failover mechanisms detect failures in real-time and switch to standby hardware or redundant pathways without interrupting ongoing RDMA operations. State synchronization keeps the virtual RDMA device aware of all communication states, such as QP statuses, ensuring continuity during transitions. One advantage of this approach is its ability to recover from faults with minimal or negligible latency. For example, if the AI-NIC encounters a link or hardware failure, the fault-tolerant mechanism reroutes data to an alternate NIC or pathway within microseconds.

From the perspective of the GPU application, the transport layer remains operational, and any failure events are entirely transparent. The transport layer refers to the protocol used to manage reliable and unreliable data transfer between RDMA-enabled endpoints. By employing the virtual RDMA device, a robust and transparent communication interface for GPU applications is provided. The underlying fault-tolerant mechanisms in the AI-NIC layer ensure reliability against failures, making the example architecture suitable for demanding AI and HPC workloads.

The examples further perform a live migration of a QP from one AI-NIC to another AI-NIC that involves handling of state, data flow, and connection integrity to ensure minimal disruption. The goal is to efficiently translate the QP state between AI-NICs while maintaining the active connection, ensuring that applications relying on the QP experience no downtime or data loss. For example, if a physical NIC experiences a failure, the virtual RDMA device isolates the failed NIC and reroutes traffic dynamically to a healthy NIC. The GPU application continues to send and receive RDMA traffic without noticing the failure. AI workloads remain uninterrupted. This prevents GPU applications from crashing or forcing a failover at the application level. Stated differently, the purpose of the virtual RDMA device is to remap or reroute RDMA traffic to a redundant, healthy NIC when an unhealthy NIC is detected, which was handling RDMA traffic of GPU applications.

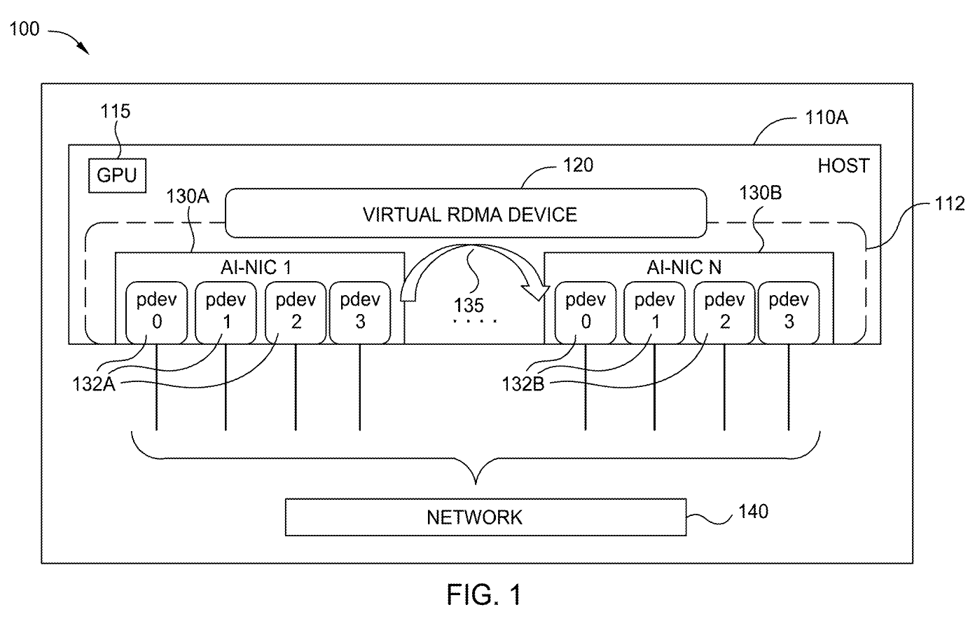

FIG. 1 illustrates a system including a host with a virtual RDMA device for handling AI-NIC failures, according to an example.

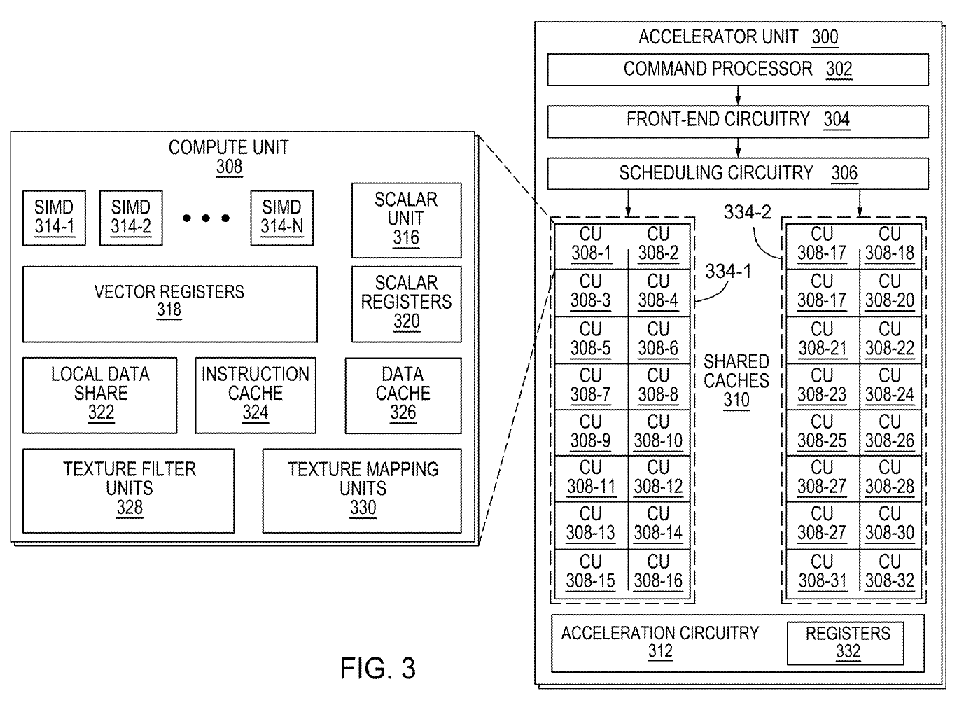

The system 100 includes a GPU 115 and a host 110A communicating with a network 140. The host 110A includes a plurality of AI-NICs and a virtual RDMA device 120. In one example, two AI-NICs are shown for illustrative purposes. In other examples, the system 100 may include more than two AI-NICs. In one example, the GPU 115 includes multiple GPUs. In one example, the GPU 115 can be included in the accelerator unit (AU) 300 described below with reference to FIG. 3.

The first AI-NIC 130A may communicate with the second AI-NIC 130B via communication link 135. The virtual RDMA device 120 works with the first AI-NIC 130A and the second AI-NIC 130B to, e.g., send data packets to the network 140. The first AI-NIC 130A includes multiple uplinks 132A (pdev0, pdev1, pdev2, pdev3) and the second AI-NIC 130B includes multiple uplinks 132B (pdev0, pdev1, pdev2, pdev3). The uplinks of each AI-NIC transfer data or data packets to the network 140. The first AI-NIC 130A, the second AI-NIC 130B, and the virtual RDMA device 120 are part of a high availability domain 112. The high availability domain 112 is a logical or physical configuration to ensure continuous operation and minimal downtime for workloads, even in the event of hardware or software failures. The virtual RDMA device 120 may also be referred to as a virtual AI-RDMA device or a virtual AI-RDMA transport device. It may be referred to as a virtual AI-RDMA device because it may be optimized for AI workloads. This terminology highlights its application in AI-driven distributed training and inference acceleration.

AI-NICs (e.g., the first AI-NIC 130A and the second AI-NIC 130B) support direct GPU-GPU communications, a requirement in modern high-performance computing (HPC) and AI workloads. AI-NICs enable efficient, low-latency data transfers between GPUs, bypassing traditional CPU-mediated communication paths and reducing bottlenecks that can hinder performance. By offloading data transport tasks to the AI-NIC, systems can achieve faster GPU-GPU data exchange, enhanced scalability, and improved resource utilization, making them ideal for large-scale distributed training and inference applications.

AI-NICs use RDMA (e.g., the virtual RDMA device 120) to facilitate zero-copy data transfers directly between GPU memory spaces. Zero-copy data transfer refers to moving data between devices (e.g., GPU, RDMA, NIC, etc.) without involving the CPU or making extra memory copies. This eliminates the need for data buffering in system memory and reduces CPU overhead, allowing GPUs to communicate directly over the network with minimal latency. Further, AI-NICs can access GPU memory directly through, e.g., a PCIe bus. This integration allows the AI-NIC to read or write data directly from GPU memory, bypassing the CPU and avoiding additional data copies. As a result, the data path between GPUs is streamlined, reducing communication time and improving throughput. AI-NICs are also capable of offloading complex networking tasks and communication protocols, such as RDMA over converged Ethernet (RoCE) and InfiniBand. By handling these protocols in hardware, the AI-NIC reduces the burden on the CPU and accelerates data transfers between GPUs across different servers.

Distributed AI training often relies on collective communication operations (e.g., all-reduce, broadcast) for model synchronization across GPUs. AI-NICs are optimized to accelerate these operations using in-network computing, reducing the time needed for gradient aggregation and synchronization in large-scale neural network training. AI-NICs provide features like adaptive routing, congestion control, and flow steering, ensuring optimal data paths for GPU-GPU communication. This helps maintain consistent performance even under heavy network traffic, minimizing latency spikes and throughput degradation.

Therefore, the benefits of using AI-NICs in direct GPU-GPU communication include at least reduced latency, higher throughput, increased scalability, and improved resource utilization.

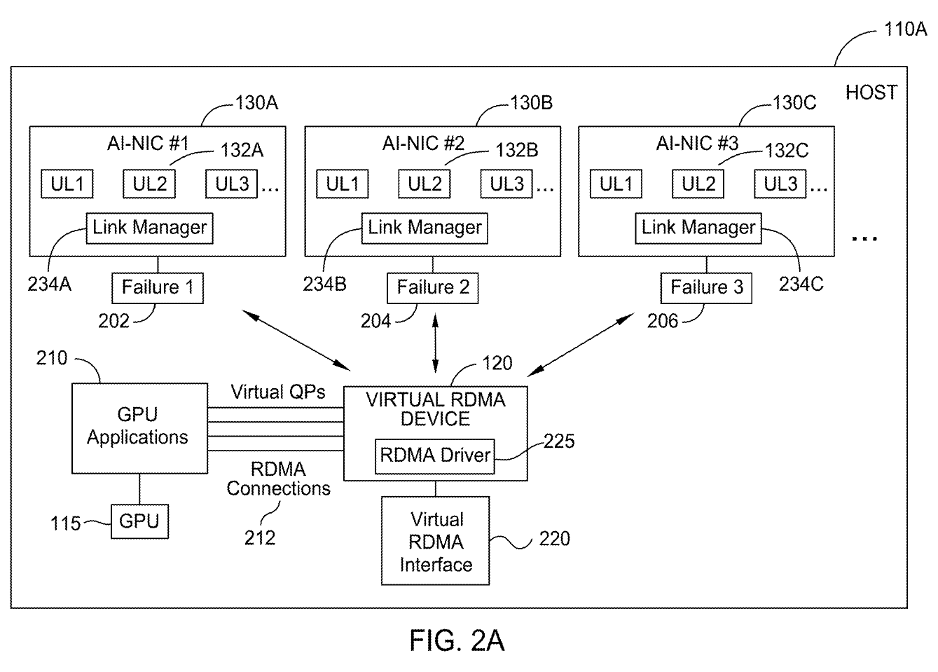

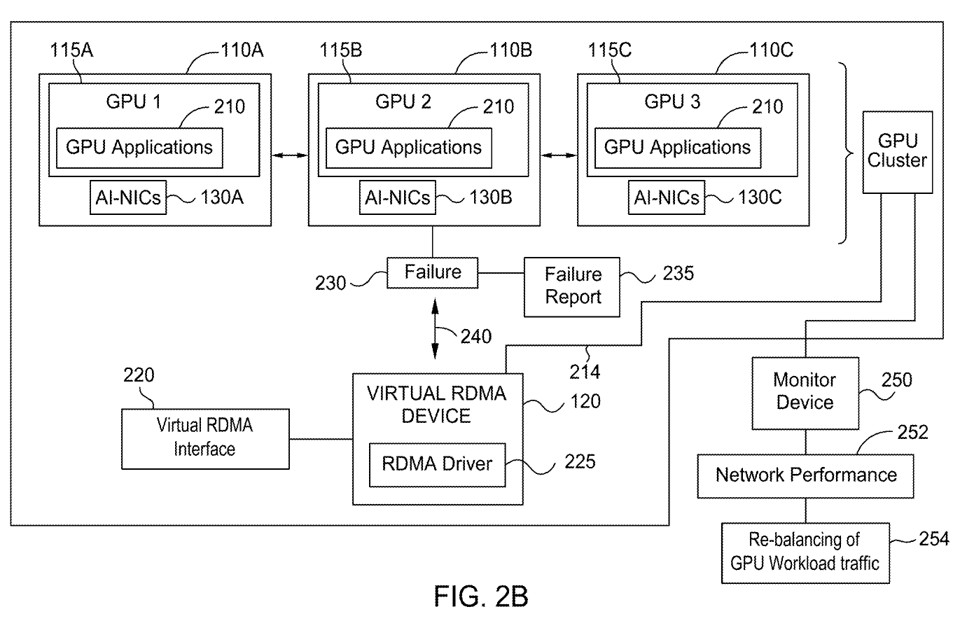

The virtual RDMA device 120 includes a virtual RDMA interface 220 (FIG. 2A). The virtual RDMA device 120 is a full RDMA-capable virtual NIC that emulates RDMA hardware, such as the AI-NICs. The virtual RDMA interface 220 (FIG. 2A) is a network endpoint that enables RDMA communication. The virtual RDMA interface 220 is created on top of the virtual RDMA device 120. The virtual RDMA interface 220 allows the AI-NICs to send and receive RDMA traffic through a logical endpoint. The virtual RDMA interface 220 manages connection setup (i.e., QPs) and RDMA transport functions over the virtual RDMA device 120. The virtual RDMA interface 220 may also be referred to as a virtual AI-RDMA interface, as it can be optimized for AI workloads and can be integrated with AI accelerators.

A QP is a fundamental communication construct in RDMA. A QP includes two queues, a send queue (SQ) and a receive queue (RQ). The SQ handles outgoing requests (e.g., read, write) and the RQ handles incoming requests. Each QP is associated with a unique identifier (QP number) and is managed by, e.g., an AI-NIC. GPU applications 210 (FIG. 2A) post work requests (WRs) to the SQ or RQ, which are then processed by the AI-NIC without involving the CPU. A complete queue (CQ) notifies the GPU application when a request is completed. QPs enable zero-copy data transfers and reduce CPU overhead by offloading network processing to the AI-NIC.

The workloads may be referred to as data transport workloads or data workloads. Data workloads refer to tasks involved in moving large volumes of data across networks or between different components or between networks and components in a computing system, e.g., a GPU. Data transport may include data collection, data transfer, data routing, data integrity and reliability, and data synchronization.

In a high-performance GPU cluster with multiple AI-NICs (FIG. 2B), exposing a single logical RDMA device (e.g., the virtual RDMA device 120) to GPUs via a RDMA driver provides a streamlined and optimized communication interface. This approach abstracts the complexity of managing multiple physical AI-NICs while ensuring efficient utilization of networking resources.

The multiple uplinks 132A and the multiple uplinks 132B provide a connection between the host 110A and external systems, such as data sources, storage arrays, cloud interfaces, or the network 140. The multiple uplinks 132A and the multiple uplinks 132B support both control traffic (orchestration signals) and data traffic (model data, gradients).

The virtual RDMA device 120 handles AI-NIC failures in a transparent manner, ensuring no downtime for GPU application traffic. This capability is beneficial for at least high-performance AI workloads, distributed training, and real-time inference where any interruption could impact performance and results.

The virtual RDMA device 120 handles AI-NIC failures by virtualization of AI-NIC resources, multipath redundancy, dynamic failover, and transparency to GPU applications. Logical RDMA abstracts physical AI-NICs into a virtualized layer, presenting a unified interface to the GPU applications. GPU applications communicate with this logical interface (i.e., the virtual RDMA interface 220, FIG. 2A) rather than directly with the physical AI-NICs. Multiple physical AI-NICs are interconnected, enabling redundancy. Logical RDMA maintains active connections across multiple AI-NICs, allowing data to reroute dynamically in case of failure. Upon detecting a failure in one AI-NIC, the virtual RDMA device 120 migrates ongoing traffic to a healthy AI-NIC without interrupting the application. Failover occurs in real-time, leveraging alternate paths or backup AI-NICs. GPU applications do not need to modify their code to handle AI-NIC failures. The virtual RDMA interface 220 manages failover and recovery processes, ensuring seamless operation.

The benefits of employing the system 100 include no downtime for GPU traffic, improved reliability, enhanced scalability, optimized performance, and cost efficiency. The system 100 ensures uninterrupted data flow for GPU applications, which is beneficial for distributed AI training, real-time inference where latency impacts user experience, and HPC where long-running jobs are sensitive to interruptions. The system 100 increases overall system availability by eliminating single points of failure and redundant AI-NICs provide failover paths, making the system 100 robust against hardware failures. GPU applications are decoupled from the complexity of managing NIC failures. Redundancy and failover mechanisms minimize performance degradation during a failure and the virtual RDMA device 120 ensures optimal path selection for data transmission, avoiding congestion and bottlenecks. The system 100 also reduces the need for manual intervention or expensive downtime recovery efforts.

FIG. 2A illustrates detection of AI-NIC failures using the virtual RDMA device, according to an example.

The host 110A may include a first AI-NIC 130A, a second AI-NIC 130B, and a third AI-NIC 130C. The first AI-NIC 130A includes multiple uplinks 132A, the second AI-NIC 130B includes multiple uplinks 132B, and the third AI-NIC 130C includes multiple uplinks 132C. The first AI-NIC 130A further includes a first link manager 234A, the second AI-NIC 130B further includes a second link manager 234B, and the third AI-NIC 130C further includes a third link manager 234C.

An AI-NIC link manager (e.g., the first link manager 234A, the second link manager 234B, and the third link manager 234C) is a software or firmware component embedded in the AI-NIC. The AI-NIC link manager manages and maintains the link integrity and communication pathways between the AI-NIC and its connected devices, such as GPUs or other networking devices.

AI workloads involve massive data transfers between GPUs. These workloads involve not only high bandwidth and low latency but also robust link reliability to ensure uninterrupted operation. The AI-NIC link manager addresses these requirements by enabling seamless communication (ensures that data flows continue uninterrupted even during transient network issues), enhancing fault tolerance (by detecting and mitigating link failures, it prevents disruptions to sensitive AI tasks, and optimizing resource use (through traffic management and load balancing to maximize the efficiency of networking hardware).

In one example, the AI-NICs may experience failures (failure events) or downtimes. In an illustrative example, a first failure 202 may be detected in the first AI-NIC 130A, a second failure 204 may be detected in the second AI-NIC 130B, and a third failure 206 may be detected in the third AI-NIC 130C.

In one example, the failures may be soft failures or hard failures. Soft failures involve temporary or recoverable issues that cause degradation in performance without complete loss of functionality. Examples of soft failures may include packet loss that causes retransmissions and latency spikes, congestion that leads to delayed communication or throttled bandwidth, and resource contention where AI-NICs are competing for shared network resources. Hard failures involve permanent or unrecoverable issues leading to disconnection or data loss. Examples of hard failures include link failure involving physical or logical disconnection between GPUs or an uplink, device failure where the AI-NIC or GPU node goes offline, and node crashes where power failure affects multiple components. As such, the AI-NIC may fail due to hardware faults, driver issues, or firmware bugs. Hard and soft failures may be caused by overheating or physical damage, aging components leading to wear and tear, bugs in firmware or driver updates, and misconfigurations or conflicts during initialization.

In another example, the failures may be uplink failures. An uplink failure occurs when the connection between the AI-NIC and the external network is disrupted. Uplink failures may be caused by a cable disconnection or a damaged cable, a switch or router malfunction, network congestion or misconfiguration and software bugs in the NIC firmware or drivers. Uplink failures may cause loss of data exchange between the GPU (or GPU cluster) and external systems (e.g., storage, external databases, cloud, networks) and disruption in distributed training or inference workflows. Uplink failures may further cause orchestration failures in tasks like workload scheduling, cluster scaling, and status monitoring and provide for increased latency or retries for failed data packets.

In another example, an AI-NIC maintenance upgrade downtime may cause a failure. Planned downtime for maintenance or firmware upgrades affects the availability of the AI-NIC and associated systems. Downtime for maintenance or firmware upgrades may be caused by firmware updates that enhance features or patch vulnerabilities, replacement or upgrade of hardware for better performance, and routine diagnostic tests or preventive maintenance. The impact of such downtime may result in reduced cluster capacity, workflow disruption, and network imbalances.

Failures in the AI-NIC can impact the GPU applications 210. For example, in distributed training, GPUs exchange gradients. GPU applications waiting for incomplete data face deadlocks or prolonged execution times. Packet loss or corruption during transmission can lead to inconsistent model updates. Further, corrupted transmissions may yield incorrect outputs or partial results. Checkpoint failures may be present where there is an inability to save or load model states due to uplink issues. Also, a failure in one component propagates to other parts of the system 100 that can cause congestion spread and cascading node failures. That is, a faulty AI-NIC causing retransmissions can congest shared network links and faulty synchronization leads to timeout or mismanagement across dependent nodes.

The integration of the virtual RDMA interface 220 ensures that the GPU applications 210 maintain seamless connectivity (via RDMA connections 212) to the virtual RDMA device 120 including an RDMA driver 225 and the virtual RDMA interface 220, even in the presence of AI-NIC failures (e.g., the first failure 202, the second failure 204, and the third failure 206). This approach abstracts the underlying hardware complexities, enabling the GPU applications 210 to function without awareness of individual AI-NIC statuses. The virtual RDMA interface 220 acts as a logical layer that manages all aspects of communication and redundancy, providing a unified interface for GPU workloads. The virtual RDMA interface 220 encapsulates the physical AI-NICs into a unified logical device, presenting a single virtual interface to the GPU applications 210. The virtual RDMA interface 220 detects the AI-NIC failures and transparently migrates active connections to healthy AI-NICs without interrupting GPU application workflow.

The virtual RDMA interface 220 is a software-defined or hardware-assisted construct that aggregates multiple physical AI-NICs (e.g., the NICs 130A-C) into a single, unified logical RDMA device. The GPU applications 210 interact with the virtual RDMA interface 220 of the virtual RDMA device 120, which ensures consistent communication paths to other GPUs, storage, or compute nodes. By virtualizing the RDMA layer, failures of any underlying AI-NIC are masked, rerouting traffic dynamically through alternate NICs without disrupting application-level operations. When a failures is detected for the, e.g., first AI-NIC 130A, the virtual RDMA interface 220 detects the fault using continuous health monitoring mechanisms. These mechanisms may include regular heartbeats, error reporting, or network diagnostics.

Upon detecting an issue, the virtual RDMA interface 220 automatically migrates active RDMA connections to a healthy AI-NIC (e.g., the second AI-NIC 130B). This failover process is handled at the virtual RDMA interface 220, ensuring that the GPU applications 210 experience no interruptions or performance degradation. The GPU applications 210 do not see or are unaware of the virtual RDMA interface 220. A healthy NIC refers to a NIC that is fully functional, performing optimally, and able to transmit and receive data without issues. A healthy NIC has no hardware or software faults, and maintains stable network connections. A healthy NIC is thus a fully functional NIC.

Stated differently, the virtual RDMA interface 220 is an abstraction that decouples the GPU applications 210 from direct NIC dependency. The virtual RDMA interface 220 provides a transparent RDMA interface to the GPU 115 (or the GPU applications 210), ensuring that hardware/software failures in a physical NIC do not disrupt ongoing AI workloads. The virtual RDMA interface 220 appears as a standard RDMA-capable NIC to the GPU applications 210. The virtual RDMA interface 220 is thus used when a physical NIC experiences a failure. In other words, if a physical AI-NIC (e.g., the first AI-NIC 130A) experiences a failure, the virtual RDMA interface 220 isolates the failed AI-NIC (e.g., the first AI-NIC 130A) and reroutes traffic dynamically to a healthy NIC (e.g., the second AI-NIC 130B). The GPU applications 210 continue to send and receive RDMA traffic without noticing the failure. Workloads thus remain uninterrupted. This prevents the GPU applications 210 from crashing or forcing a failover at the application level. As such, the purpose of the virtual RDMA interface 220 is to remap or reroute RDMA traffic to a redundant, healthy NIC (e.g., the second AI-NIC 130B) when an unhealthy NIC (e.g., the first AI-NIC 130A) is detected (which was handling RDMA traffic of the GPU applications 210).

The examples perform a live migration of a QP from one AI-NIC to another AI-NIC that involves handling of state, data flow, and connection integrity to ensure minimal disruption. The goal is to efficiently translate the QP state between AI-NICs while maintaining the active connection, ensuring that applications relying on the QP experience no downtime or data loss. A QP in the RDMA includes all the information needed to manage and execute remote memory operations. This includes control state, connection state, buffers, and resources. To migrate a QP, all these elements need to be transferred accurately to the destination AI-NIC while preserving consistency and order of operations. The key to efficient live migration is the ability to quickly translate and transfer the QP state from one AI-NIC to another. This may involve state serialization, incremental updates, and hardware acceleration.

The QP may be a virtual QP, which is an abstracted, software-managed QP used in virtualized RDMA environments, where multiple GPU applications 210 share the virtual RDMA device 120. The virtual QPs allow the GPU applications 210 to communicate over the virtual RDMA interface 220. The virtual QPs) are transmitted between the processor applications and the virtual RDMA device 120. In operation, a GPU application submits an RDMA work request (WR). The WR is mapped to an available virtual QP instead of a physical QP. The virtual RDMA interface 220 assigns the virtual QP request to a physical QP. The AI-NIC (e.g., the first AI-NIC 130A) processes the request, as the data is transferred from the GPU memory to the AI-NIC without GPU involvement. The AI-NIC (e.g., the first AI-NIC 130A) updates the CQ, signaling completion to the virtual RDMA interface 220. The virtual RDMA interface 220 maps the completion event back to the correct GPU application.

For example, the source AI-NIC (e.g., the first AI-NIC 130A) may serialize the QP state into a transferable format. This includes the current control and connection states, work queue entries, and any in-flight data. Instead of transferring the entire QP state in one instance, incremental updates can be applied in certain examples. In one example, these updates capture only the changes to the QP state during migration, reducing the volume of data transferred. Both the source and destination AI-NICs (e.g., the first AI-NIC 130A and the second AI-NIC 130B) can use hardware accelerators to compress and decompress state data, ensuring that the transfer is efficient and fast.

Further, ensuring connection integrity is necessary during live migration. This may involve dual-NIC operation, connection re-routing, and transaction logging. For example, for the duration of the migration, both AI-NICs (e.g., the first AI-NIC 130A and the second AI-NIC 130B) can temporarily share responsibility for the QP. The source AI-NIC (e.g., the first AI-NIC 130A) continues handling active operations while the destination AI-NIC (e.g., the second AI-NIC 130B) begins receiving state updates. The connection can be rerouted from the source to the destination AI-NIC seamlessly. This may involve updating routing tables or modifying hardware pathways to ensure packets reach the destination without interruption. A transaction log of unacknowledged or in-flight operations may be maintained. Once the migration is complete, the destination AI-NIC (e.g., the second AI-NIC 130B) replays these transactions to maintain the correct sequence of operations.

After the state has been transferred, and the destination AI-NIC (e.g., the second AI-NIC 130B) is prepared to take over, the next operations may involve state synchronization, switch-over, and error handling. For example, the source AI-NIC (e.g., the first AI-NIC 130A) synchronizes the latest updates with the destination AI-NIC (e.g., the second AI-NIC 130B), ensuring that both have an identical view of the QP state. The connection is switched entirely to the destination AI-NIC (e.g., the second AI-NIC 130B), and the source AI-NIC (e.g., the first AI-NIC 130A) gracefully exits the operation. Acknowledgment mechanisms ensure that the destination is ready to handle all new operations before the switch-over. In case of issues during migration, the system 100 of FIG. 1 may have a rollback mechanism to revert the QP to the source AI-NIC (e.g., the first AI-NIC 130A), ensuring uninterrupted operation.

Efficient live migration of QPs between AI-NICs is beneficial for load balancing, fault tolerance, and resource optimization. Load balancing may involve dynamic redistribution of workload between AI-NICs to optimize network performance. Fault tolerance may involve seamlessly transferring QPs from a failing AI-NIC to a healthy one without service disruption. Resource optimization may involve migrating QPs to balance resource utilization across AI-NICs in multi-node systems.

Stated differently, performing a live migration of a QP from one AI-NIC (e.g., the first AI-NIC 130A) to another AI-NIC (e.g., the second AI-NIC 130B) using the virtual RDMA interface 220 introduces an abstraction layer that is invisible to the GPU applications 210. This approach ensures seamless migration while preserving the operational transparency needed by high-performance applications, such as those running on GPUs. The virtual RDMA interface 220 decouples the migration process from the GPU application’s direct interaction with the QP, enabling efficient and disruption-free transitions. The virtual RDMA interface 220 acts as an intermediary between the GPU applications 210 and the underlying AI-NIC hardware. From the perspective of the GPU application, the QP remains consistent and unaffected throughout the migration process. The virtual RDMA interface 220 may abstract physical resources. That is, the QP is presented as a logical entity that is not bound to a specific AI-NIC. The virtual RDMA interface 220 may manages migration logic by handling the intricacies of transferring QP state and connections between the source and destination AI-NICs (e.g., the first AI-NIC 130A and the second AI-NIC 130B). The virtual RDMA interface 220 may ensure transparency, that is, the GPU applications 210 continue their operations without needing to be aware of the migration. This abstraction allows for flexible resource management and robust fault tolerance in distributed systems. As such, GPU applications 210 remain unaffected, as the migration occurs entirely within the virtual RDMA interface 220 and underlying AI-NICs (e.g., the first AI-NIC 130A, the second AI-NIC 130B, and the third AI-NIC 130C). The virtual RDMA interface 220 ensures smooth state and connection migration without dropping packets or causing delays and QPs can be migrated flexibly to optimize resource usage, balance loads, or address hardware failures.

Further, another benefit of the virtual RDMA interface 220 is that the GPU applications 210 are unaware of AI-NIC failures. This transparency is achieved by maintaining consistent RDMA QPs and communication states within the virtual RDMA interface 220, even as physical connections are switched. GPU applications 210 continue to send and receive data without code modifications or awareness of the failover event.

FIG. 2B illustrates a cluster of GPUs communicating with the virtual RDMA device, according to an example.

The cluster of GPUs includes a first GPU 115A, a second GPU 115B, and a third GPU 115C. The cluster of GPUs may include more or less GPUs. In one example, the cluster of GPUs may include dozens or even hundreds of GPUs. The first GPU 115A runs GPU applications 210A, the second GPU 115B runs GPU applications 210B, and the third GPU 115C runs GPU applications 210C. Stated differently, the GPUs process computational tasks offloaded by GPU applications. The GPU applications are software applications that leverage computational power of the GPUs for specific tasks. Further, the first host 110A may include the first AI-NIC 130A, the second host 110B may include the second AI-NIC 130B, and the third host 110C may include the third AI-NIC 130C. The GPU applications of the GPUs of the GPU cluster communicate with the virtual RDMA device 120 via link 214.

In one example, the second AI-NIC 130B of the second host 110B may experience a failure 230. A failure report 235 may be generated outlining the specifics of the failure 230. The failure report 235 may provide a detailed account of the failure 230, its impact, mitigation, and recommendations.

The failure 230 is detected by the virtual RDMA device 120 including the virtual RDMA interface 220. The virtual RDMA device 120 may detect transport layer failures and hardware level errors. In one example, the failure 230 can be a QP error. If a QP encounters an invalid state transition, the virtual RDMA device 120 marks it as an error and notifies the CQ. In another example, the failure 230 can be a transport level failure such as a packet loss, duplicate acknowledgments (ACKs), or timeout-based retransmissions. Thus, transport or QP related failures are handled by the virtual RDMA interface 220 of the virtual RDMA device 120. In other examples, if a failure is a network-wide failure, it is possible for a monitoring device 250, described below, to detect and flag the failure. However, in most cases, failures are identified by the virtual RDMA interface 220 of the virtual RDMA device 120.

The failure 230 is communicated (via a bidirectional communication link 240) to the virtual RDMA interface 220 of the virtual RDMA device 120 including the RDMA driver 225. The RDMA driver 225 abstracts the underlying hardware complexity and provides a unified application programming interface (API) to the GPU applications 210. In one example, the RDMA driver 225 may map the virtual QPs to physical resources and may manage the physical AI-NICs transparently. In other words, the RDMA driver 225 may allocate and manage resources such as memory buffers, virtual QPs, and CQs.

The virtual QP is an abstracted, software-managed QP used in virtualized RDMA environments, where multiple GPU applications 210 share the virtual RDMA device 120. The virtual QPs allow the GPU applications 210 to communicate over the virtual RDMA interface 220. In operation, as noted above, a GPU application submits an RDMA WR. The WR is mapped to an available virtual QP instead of a physical QP. The virtual RDMA interface 220 assigns the virtual QP request to a physical QP. The AI-NIC (e.g., the first AI-NIC 130A) processes the request, as the data is transferred from the GPU memory to the AI-NIC without GPU involvement. The AI-NIC (e.g., the first AI-NIC 130A) updates the CQ, signaling completion to the virtual RDMA interface 220. The virtual RDMA interface 220 maps the completion event back to the correct GPU application.

The GPU cluster may be coupled to a monitoring device 250 that tracks network performance 252 and dynamically rebalances workload traffic 254 across the GPU cluster and network resources. This approach enhances throughput, reduces latency, and ensures fault tolerance in distributed computing environments.

The monitoring device 250 operates as an intermediary layer that continuously assesses network health and performance metrics. Parameters such as bandwidth utilization, latency, packet loss rates, and network congestion are tracked in real-time. The monitoring device 250 can also integrate telemetry data from network components such as the AI-NICs (e.g., the AI-NICs 130A-130C). By analyzing this data, the system 100 of FIG. 1 can detect anomalies such as bottlenecks or failed links. For example, if a specific AI-NIC (e.g., the first AI-NIC 130A) experiences reduced throughput due to congestion or hardware degradation, the monitoring device 250 flags this condition and notifies the GPU workload management system. This capability ensures the network remains performant and supports the high data transfer requirements of distributed GPU workloads.

When network performance issues are detected, the virtual RDMA interface 220 may trigger rebalancing mechanisms to redistribute GPU traffic. For example, the virtual RDMA interface 220 can dynamically adjust which AI-NICs (e.g., of the AI-NICs 130A-130C) handle traffic, redistributing workloads from overburdened or degraded NICs to healthy ones. This ensures even utilization across network interfaces and prevents single points of failure. For multi-GPU setups in a data center, the system 100 may reroute traffic through alternative network paths to avoid congestion or reduce latency. In case of an AI-NIC failure (e.g., of the first AI-NIC 130A), the monitoring device 250 works with the virtual RDMA interface 220 to seamlessly failover traffic to other operational AI-NICs (e.g., the third AI-NIC 130C), ensuring uninterrupted GPU operations.

The benefits of monitoring and rebalancing may include improved fault tolerance, where automatic detection and handling of network issues reduce downtime and prevent task failures. Optimized resource utilization that ensures even distribution of workloads across GPUs and network interfaces, maximizing the efficiency of the hardware. Scalable performance to support scaling workloads across multiple GPUs and clusters by adapting dynamically to changing network conditions. Reduced latency where real-time rebalancing minimizes the latency caused by congestion or hardware failures, maintaining consistent performance.

To summarize, referring to FIGS. 1-2B, AI-NICs (e.g., the AI-NICs 130A-130C) facilitate high-speed GPU-GPU communication in distributed AI workloads. The AI-NICs can handle large data transfers, offload networking tasks, and support advanced communication protocols like RDMA. However, as the AI-NICs (e.g., the AI-NICs 130A-130C) take on a significant portion of the data transport workload, the AI-NICs also become a potential point of failure, with numerous issues that can disrupt GPU-GPU communication.

The AI-NICs (e.g., the AI-NICs 130A-130C) can experience various failure scenarios. Failures may include hardware failures, software and firmware failures, protocol-specific failures, resource exhaustion failures, network path and topology failures, and thermal and power failures.

Regarding hardware failures, the AI-NICs (e.g., the AI-NICs 130A-130C) include various components like memory, processing units, and transceivers. Hardware malfunctions, such as memory errors or chip faults, can lead to packet loss, corrupted data, or complete NIC failure, severing the direct communication path between GPUs. Physical issues, such as degraded or broken optical/electrical links (e.g., PCIe connectors), can cause intermittent connectivity or loss of the high-speed data path. Link degradation may go undetected initially, resulting in intermittent packet loss and reduced throughput.

Regarding software and firmware failures, the AI-NICs (e.g., the AI-NICs 130A-130C) rely on specialized drivers for handling low-latency data transport and RDMA operations. Bugs, memory leaks, or resource contention within these drivers can lead to crashes, causing the AI-NIC to become unresponsive and disrupt ongoing data transfers. Firmware updates or glitches can corrupt the AI-NIC’s internal state, affecting its ability to manage connections and data paths. Corrupted firmware may lead to incorrect routing of data, communication stalls, or complete disconnection of the affected GPUs. Mismatches in configuration parameters (e.g., maximum transmission unit (MTU) size, queue depth, or RDMA settings) between AI-NICs and GPUs can lead to failed connection setups or degraded performance. Inconsistent configurations may trigger packet fragmentation, increased latency, or frequent retransmissions.

Regarding protocol-specific failures, RDMA, commonly used for high-speed GPU-GPU data transfer, relies on maintaining a consistent connection state between AI-NICs. Issues like queue pair timeouts, incorrect memory registration, or access control list (ACL) violations can result in RDMA connection failures, disrupting direct memory access between GPUs. RoCE relies on efficient congestion management. Network congestion or inadequate congestion control mechanisms can cause severe packet loss or high latency, leading to timeouts and RDMA connection resets.

Regarding resource exhaustion failures, AI-NICs use descriptors and completion queues to manage data transfers. High workloads can exhaust these resources, especially in large-scale distributed training scenarios where numerous data streams are active. Descriptor shortages may cause transfer stalls, delays, or dropped packets. AI-NICs use internal buffers for handling data before transfer. High data rates and burst traffic can lead to buffer overflow, resulting in packet drops and incomplete transfers.

Regarding network path and topology failures, AI-NICs participate in complex network topologies that include multiple switches and routers. Failures in the network path, such as switch failures or routing loops, can disrupt the direct data path between GPUs, causing timeouts and retries. In distributed AI training, multicast and broadcast messages are frequently used for gradient aggregation and synchronization. AI-NICs configured incorrectly for multicast traffic may experience packet loss or misrouting, causing delays in synchronization and reducing model convergence speed.

Regarding thermal and power failures, AI-NICs are tasked with handling high-bandwidth data transfers, generating significant heat. Poor cooling or ventilation can lead to overheating, causing thermal throttling or shutdowns. This results in reduced data transfer rates or complete loss of connectivity. AI-NICs demand stable power to maintain high-speed operations. Power fluctuations or supply interruptions can lead to unexpected resets or damage to the NIC, disrupting active data transfers.

Therefore, AI-NIC failures can lead to performance degradation in GPU-GPU communication. Common effects include increased latency, reduced throughput, data corruption, communication stalls, and, in worst-case scenarios, the failure of the entire workload. In view of such failures, the examples present the virtual RDMA interface 220 that ensures that the GPU applications 210 maintain seamless connectivity (via the RDMA connections 212) to the virtual RDMA device 120 and the virtual RDMA interface 220, even in the presence of AI-NIC failures. This approach abstracts the underlying hardware complexities, enabling the GPU applications 210 to function without awareness of individual AI-NIC statuses. The virtual RDMA interface 220 acts as a logical layer that manages all aspects of communication and redundancy, providing a unified interface for GPU workloads. The virtual RDMA interface 220 encapsulates the physical AI-NICs into a unified logical device, presenting a single virtual interface to the GPU applications 210. The virtual RDMA interface 220 detects the AI-NIC failures and transparently migrates active connections to healthy AI-NICs (e.g., the second AI-NIC 130B) without interrupting GPU application workflow.

As such, the GPU applications 210 interact with the virtual RDMA interface 220, which ensures consistent communication paths to other GPUs, storage, or compute nodes. By virtualizing the RDMA layer, the virtual RDMA interface 220 masks failures of any underlying AI-NIC, rerouting traffic dynamically through alternate NICs without disrupting application-level operations. When an AI-NIC failure occurs, the virtual RDMA interface 220 detects the fault using continuous health monitoring mechanisms. Upon detecting an issue, the virtual RDMA interface 220 automatically migrates active RDMA connections to a healthy AI-NIC. This failover process is handled at the virtual RDMA interface 220, ensuring that the GPU applications 210 experience no interruptions or performance degradation.

FIG. 3 is a block diagram of an accelerator unit (AU) configured to execute workloads for applications running on a processing system, in accordance with some examples.

FIG. 3 presents an AU 300 configured to execute workloads for one or more applications running on a processing system. These applications include, for example, compute applications, graphics applications, or both each configured to issue respective series of instructions, also referred to herein as “threads,” to a central processing unit (CPU) of the processing system. Compute applications, when executed by a processing system, cause the processing system to perform one or more computations, such as machine-learning, neural network, high-performance computing, or databasing computations. Further, graphics applications, when executed by a processing system, cause the processing system to render a scene including one or more graphics objects and, as an example, output the scene on a display. The instructions issued to the CPU from these applications, for example, include groups of threads, also referred to herein as “workgroups,” to be executed by AU 300. To perform these workgroups, AU 300 includes one or more vector processors, coprocessors, graphics processing units (GPUs), general-purpose GPUs, non-scalar processors, highly parallel processors, artificial intelligence (AI) processors, inference engines, machine-learning processors, or any combination thereof. As an example, AU 300 includes one or more command processors 302, front-end circuitry 304, scheduling circuitry 306, compute units 308, shared caches 310, and acceleration circuitry 312.

A command processor 302 of AU 300 is configured to receive, from the CPU, a command stream indicating one or more workgroups to be executed. As an example, based on a compute application running on the processing system, the command processor 302 receives a command stream indicating workgroups that involve compute operations such as matrix multiplication, addition, subtraction, and the like to be performed. As another example, based on a graphics application running on the processing system, the command processor 302 receives a command stream indicating workgroups that include draw calls for a scene to be rendered. After receiving a command stream, the command processor 302 parses the command stream and issues respective instructions of the indicated workgroups to front-end circuitry 304, scheduling circuitry 306, or both. As an example, based on a command stream from a graphics application, the command processor 302 issues one or more draw calls to front-end circuitry 304 that includes one or more vertex shaders, polygon list builders, and the like. From the instructions issued from the command processor 302, front-end circuitry 304 is configured to position geometry objects in a scene, assemble primitives in a scene, cull primitives, perform visibility passes for primitives in a scene, generate visible primitive lists for a scene, or any combination thereof. For example, based on a set of draw calls received from a command processor 302, front-end circuitry 304 determines a list of primitives to be rendered for a scene. After determining a list of primitives to be rendered for a scene, the front-end circuitry 304 issues one or more draw calls (e.g., a workgroup) associated with the primitives in the list of primitives to scheduling circuitry 306.

Based on the instructions of the workgroups received from a command processor 302, front-end circuitry 304, or both, scheduler circuitry 306 is configured to provide data indicating threads (e.g., operations for these threads) to be executed for these workgroups to one or more compute units 308. Each compute unit 308 is configured to support the concurrent execution of two or more threads of a workgroup. For example, each compute unit 308 is configured to concurrently execute a predetermined number of threads referred to herein as a “wavefront.” Based on the size of the wavefront of a compute unit 308, scheduler circuitry 306 schedules one or more groups of threads of the workgroup, also referred to herein as “waves,” to be executed by the compute unit 308. As an example, scheduler circuitry 306 first updates one or more registers of a compute unit 308 such that the compute unit 308 is configured to execute a first group of waves of the workgroup. After the compute unit 308 has executed the first group of waves, scheduler circuitry 306 updates one or more registers of the compute unit 308 to schedule a second group of waves of the workgroup to be executed by the compute unit 308. To execute these waves, each compute unit is connected to one or more shared caches 310 that each include a volatile memory, non-volatile memory, or both accessible by one or more compute units 308. These shared caches 310, for example, are configured to store data (e.g., register files, values, operands, instructions, variables) used in the execution of one or more waves, data resulting from the performance of one or more waves, or both. Because a shared cache 310 is accessible by two or more compute units 308, a first compute unit 308 is enabled to provide results from the execution of a first wave to a second compute unit 308 executing a second wave. Though the examples presented in FIG. 3 shows AU 300 as including 32 compute units (308-1 to 308-32), in other implementations, AU 300 can include any number of compute units 308.

Each compute unit 308 includes one or more single instruction, multiple data (SIMD) units 314, a scalar unit 316, vector registers 318, scalar registers 320, local data share 322, instruction cache 324, data cache 326, texture filter units 328, texture mapping units 330, or any combination thereof. A SIMD unit 314 (e.g., a vector processor) is configured to concurrently perform multiple instances of the same operation for a wave. For example, a SIMD unit 314 includes two or more lanes each including an arithmetic logic unit (ALU) and each configured to perform the same operation for the threads of a wave. Though the examples presented in FIG. 3 shows a compute unit 308 including three SIMD units (314-1, 314-2, 314-N) representing an N number of SIMD units, in other implementations, a compute unit 308 can include any number of SIMD units 314. Further, as an example, the size of a wavefront supported by AU 300 is based on the number of SIMD units 314 included in each compute unit 308. To determine the operations performed by the SIMD units 314, each compute unit 308 includes vector registers 318 formed from one or more physical registers of AU 300. These vector registers 318 are configured to store data (e.g., operands, values) used by the respective lanes of the SIMD units 314 to perform a corresponding operation for the wave. Additionally, each compute unit 308 includes a scalar unit 316 configured to perform scalar operations for the wave. As an example, the scalar unit 316 includes an ALU configured to perform scalar operations. To support the scalar unit 316, each compute unit 308 includes scalar registers 320 formed from one or more physical registers of accelerator unit 300. These scalar registers 320 store data (e.g., operands, values) used by the scalar unit 316 to perform a corresponding scalar operation for the wave.

Further, each compute unit 308 includes a local data share 322 formed from a volatile memory (e.g., random-access memory) accessible by each SIMD unit 314 and the scalar unit 316 of the compute unit 308. That is to say, the local data share 322 is shared across each wave concurrently executing on the compute unit 308. The local data share 322 is configured to store data resulting from the execution of one or more operations for one or more waves, data (e.g., register files, values, operands, instructions, variables) used in the execution of one or operations for one or more waves, or both. As an example, the local data share 322 is used as a scratch memory to store results for aiding in, or helpful for the performance of one or more operations by one or more SIMD units 314. The instruction cache 324 of a compute unit 308, for example, includes a volatile memory, non-volatile memory, or both configured to store the instructions to be executed for one or more waves to be executed by the compute unit 308. Further, the data cache 326 of a compute unit 308 includes a volatile memory, non-volatile memory, or both configured to store data (e.g., register files, values, operands, variables) used in the execution of one or more waves by the compute unit 308. The instruction cache 324, data cache 326, shared caches 310, and a system memory, for example, are arranged in a hierarchy based on the respective sizes of the caches. As an example, based on such a cache hierarchy, a compute unit 308 first requests data from a controller of a corresponding data cache 326. Based on the data not being in the data cache 326, the data cache 326 requests the data from a shared cache 310 at the next level of the cache hierarchy. The caches then continue in this way until the data is found in a cache or requested from the system memory, at which point, the data is returned to the compute unit 308. Additionally, each compute unit 308 includes one or more texture mapping units 330 each including circuitry configured to map textures to one or more graphics objects (e.g., groups of primitives) generated by the compute units 308. Further, each compute unit 308 includes one or more texture filter units 328 each having circuitry configured to filter the textures applied to the generated graphics objects. For example, the texture filter units 328 are configured to perform one or more magnification operations, anti-aliasing operations, or both to filter a texture.

Additionally, to help perform instructions for one or more workgroups, AU 300 includes acceleration circuitry 312. Such acceleration circuitry 312 includes hardware (e.g., fixed-function hardware) configured to execute one or more instructions for one or more workgroups. As an example, acceleration circuitry 312 includes one or more instances of fixed function hardware configured to encode frames, encode audio, decode frames, decode audio, display frames, output audio, perform matrix multiplication, or any combination thereof. To schedule instructions for execution on such hardware, scheduling circuitry 306 is configured to update one or more physical registers 332 of AU 300 associated with the hardware. In some cases, AU 300 includes one or more compute units 308 grouped into one or more shader engines 334. Referring to the example in FIG. 3, for example, AU 300 includes compute units 308-1 to 308-16 grouped in a first shader engine 334-1 and compute units 308-17 to 308-32 grouped in a second shader engine 334-2. Such shader engines 334, for example, are configured to execute one or more workgroups (e.g., one or more compute kernels) for an application and include one or more compute units 308, graphics processing hardware (e.g., primitive assemblers, rasterizers), one or more shared caches 310, render backends, or any combination thereof. Though the example in FIG. 3 shows AU 300 as including two shader engines (334-1, 334-2), in other implementations, AU 300 can include any number of shader engines (334-1, 334-2).

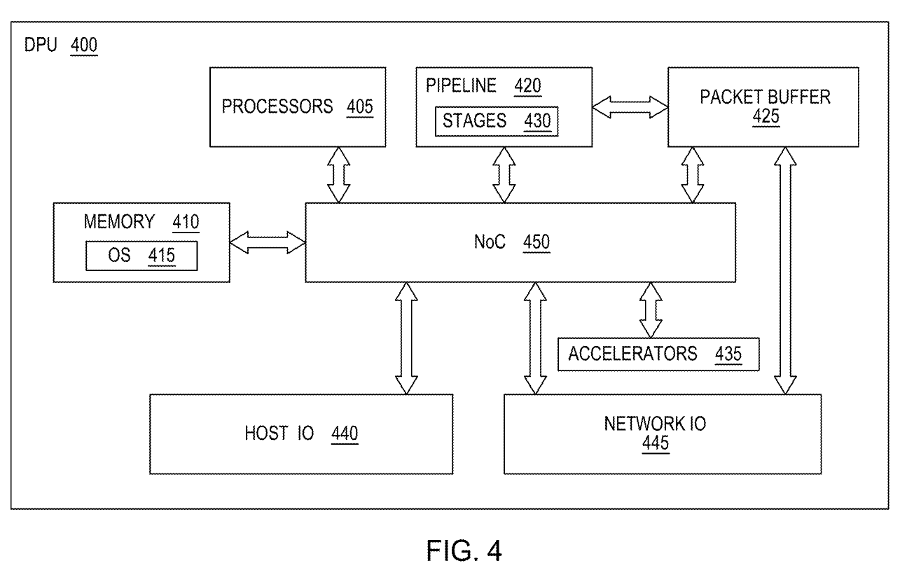

FIG. 4 is a block diagram of a data processing unit (DPU) that may be used to implement e.g., the first AI-NIC 130A, the second AI-NIC 130B, the third AI-NIC 130C, in accordance with some examples.

In one example, the DPU 400 is a programmable processor designed to efficiently handle data-centric workloads such as data transfer, reduction, security, compression, analytics, and encryption, at scale in data centers. The DPU 400 can improve the efficiency and performance of data centers by offloading workloads from a host central processing unit (CPU) or graphic processing units (GPUs). While CPUs and GPUs can specialize on compute, the DPU may specialize in data movement. The DPU 400 can communicate with host CPUs and GPUs to enhance computing power and the handling of complex data workloads.

The DPU 400 includes a plurality of processors 405. In one example, the processors 405 include any number of processing cores. In one example, the processors 405 may be CPUs. The processors 405 can form one or more CPU core complexes. The processors 405 can be any hardware circuitry that uses an instruction set architecture (ISA) to process data, such as a complex instruction set computer (CISC) or reduced instruction set computer (RISC).

The memory 410 can include volatile or non-volatile memory such as random access memory (RAM), high bandwidth memory (HBM), and the like. The memory 410 can include an operating system (OS) 415 that is separate from the host OS.

In one example, the DPU may be in (or be used to implement) a network interface controller/card (NIC) such as a SmartNIC that processes packets before they are forwarded to a host (e.g., a host CPU or GPU). In one example, the DPUs 400 are fully programmable P4 DPUs. The DPU 400 includes multiple pipelines 420 (which can be the same type or different types) for processing received network packets stored in a packet buffer 425. In this example, the pipelines 420 has direct connections to the packet buffer 425.

The pipelines 420 can operate in parallel. Further, the pipelines 420 can be the same type of pipeline (e.g., perform the same tasks). In other examples, the DPU 400 may have different types of pipelines 420. For example, the DPU 400 could include networking pipelines which perform networking tasks such as combining packets that were subdivided to be compatible with a maximum transmission unit (MTU) or for dealing with one or more host operating systems, drivers, and/or message descriptor formats in host memory, and could also include direct memory access (DMA) pipelines which perform memory reads and writes.

The pipelines 420 include multiple stages 430 where received packet data is processed at each stage 430 before being passed to the next stage. This packet data could be the entire packet or just a portion of the packet. For example, a parser in the DPU 400, which is upstream from the pipelines 420, may parse out a particular portion of a received packet (e.g., a packet header vector (PHV)) which is then sent to the one of the pipelines 420.

The stages 430 can include circuitry or hardware. In one example, the stages 430 can be programmed using a pipeline programming language, such as P4. In one example, the stages 430 in one pipeline 420 perform the same functions of the stages 430 in another pipeline 420. However, in other examples, the stages may perform different functions.

In addition to the stages, the pipelines 420 may each include memory, which can be referred to as local memory. This memory can store local tables that indicate how, or if, a particular packet should be processed at the stages 430. For example, one of the stages in the pipelines 420 can perform a lookup to read a policing entry in a table to determine whether an entity associated with the packet has exceeded a rate limit (e.g., a packet rate limit, a data rate limit, or both).

The DPU 400 can include accelerators 435 to perform specialized tasks associated with data movement. The accelerators 435 can include a cryptography accelerator, a data compression accelerator, as well as accelerators for performing regex or dedupe.

To communicate with the host and a network, the DPU 400 includes host input/output (IO) 440 and network IO 445. The host IO 440 can include a PCIe interface, or any suitable protocol for communicating with a CPU or GPU in the host. The network IO 445 can include Ethernet interfaces, and the like for communicating with a network.

The DPU 400 includes a network on chip (NoC) 450 for interconnecting the various components discussed above. While a NoC is disclosed, the DPU 400 can include any suitable on-chip network. While some components in the DPU 400 may rely on the NoC 450 to communicate with other components, the DPU 400 can also include connections between components that bypass the NoC 450. For example, the packet buffer 425 can have a connection to the network IO 445 that bypasses the NoC 450. Similarly, the pipelines 420 can exchange packet data with the packet buffer 425 without having to rely on the NoC 450. However, to transfer data to the processors 405, the pipelines 420 may use the NoC 450.

In one example, the DPU 400 includes security and management features such as offering a hardware root of trust, secure boot, and the like.

FIG. 5 is a flowchart 500 for detecting an uplink failure, in accordance with some examples.

At 510, the AI-NIC link manager (e.g., the link manager 234A-C) detects an uplink failure. The AI-NIC link manager identifies the affected path and initiates failover procedures to maintain uninterrupted communication.

At 520, the virtual RDMA device 120 rebalances outgoing traffic onto remaining active uplinks (with the failure not visible to the GPU/host). This process may use dynamic traffic redistribution mechanisms, allowing the virtual RDMA device 120 to reroute data streams without interrupting ongoing GPU application workflows. The virtual RDMA device 120 abstracts the underlying hardware changes so that the GPU application remain unaware of the AI-NIC failure.

At 530, optionally, the virtual RDMA device 120 reports the uplink failure. This optional reporting allows the RDMA driver 225 to maintain a more comprehensive view of the network health of the system 100. While the GPU applications remain unaware of the failure, the RDMA driver 225 can record the event and its impact.

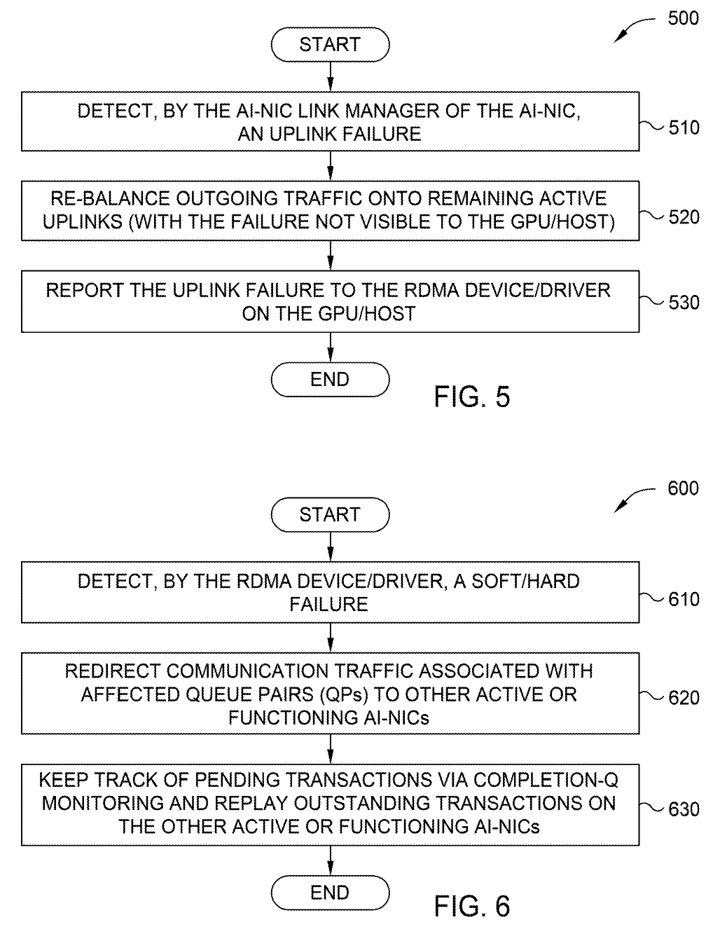

FIG. 6 is a flowchart 600 for detecting a soft/hard failure, in accordance with some examples.

At 610, the virtual RDMA device 120 detects a soft/hard failure. The soft failure indicates a temporary issue, which can be handled by retransmitting the data or rerouting traffic.

At 620, the virtual RDMA device 120 redirects communication traffic associated with affected QPs to other active or functioning AI-NICs. The virtual RDMA device 120 reconfigures the routing of data to ensure uninterrupted communication using healthy AI-NICs. This seamless failover process ensures that the GPU applications 210 are unaffected by the failure, as the traffic shift occurs transparently.

At 630, the monitoring device 250 keeps track of pending transactions via completion-Q monitoring and replays outstanding transactions on the other active or functioning AI-NICs. The monitoring device 250 identifies outstanding transactions in the affected QPs by examining the CQs. The monitoring device 250 replays the outstanding transactions on other healthy AI-NICs. The replay mechanism is seamless and transparent to the GPU applications 210.

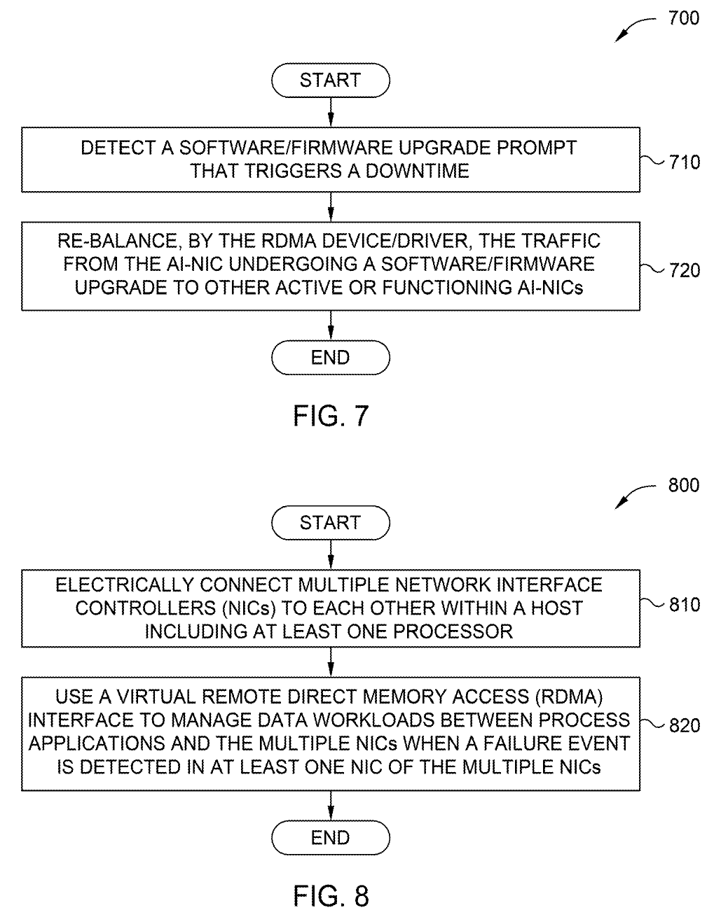

FIG. 7 is a flowchart 700 for detecting a software/firmware upgrade, in accordance with some examples.

At 710, the virtual RDMA device 120 detects a software/firmware upgrade that may trigger a downtime. This downtime allows the virtual RDMA device 120 to load new software or firmware and apply configurations.

At 720, the virtual RDMA device 120 redirects the traffic from the AI-NIC undergoing a software/firmware upgrade to other active or functioning AI-NICs. The virtual RDMA device 120 abstracts the underlying hardware changes and manages the redirection of traffic, automatically rerouting data to available AI-NICs without manual intervention.

FIG. 8 is a flowchart 800 for using the virtual RDMA device to manage data workloads, in accordance with some examples.

At 810, the virtual RDMA device 120 detects a failure event in at least one NIC of a plurality of NICs within a host including at least one processor.

At 820, the virtual RDMA device 120 rebalances data traffic to one or more functional NICs of the plurality of NICs.

In conclusion, the examples present a system and method for ensuring that GPU applications remain unaffected by underlying hardware or software failures, by presenting an architecture including a virtual RDMA device. The virtual RDMA device is available to GPU applications, abstracting away the complexities of the underlying AI-NIC layer. By doing so, GPU workloads can execute uninterrupted, even when the AI-NIC encounters issues, significantly enhancing application reliability. The virtual RDMA device serves as a logical interface for GPU applications, creating a consistent RDMA transport endpoint. The virtual RDMA device decouples the application layer from the physical NIC, enabling GPU applications to remain unaware to hardware specifics or failures. This abstraction is achieved by implementing a fault-tolerant mechanism at a lower layer beneath the virtual device. The fault-tolerant layer monitors the health of the AI-NIC and manages failover or recovery mechanisms without exposing these events to the application layer. The fault-tolerant mechanism ensures RDMA operations remain reliable. In other words, such an approach ensures that data flows, buffer management, and RDMA operations continue seamlessly, irrespective of transient or permanent NIC-related issues.

The virtual RDMA device is an abstraction that decouples GPU applications from direct NIC dependency. The virtual RDMA device provides a transparent RDMA interface to the GPU (or GPU applications), ensuring that hardware/software failures in a physical NIC do not disrupt ongoing AI workloads. The virtual RDMA device appears as a standard RDMA-capable NIC to the GPU applications. The virtual RDMA device is thus used when a physical NIC experiences a failure. In other words, if a physical NIC experiences a failure, the virtual RDMA device isolates the failed NIC and reroutes traffic dynamically to a healthy NIC. The GPU application continues to send and receive RDMA traffic without noticing the failure. This prevents GPU applications from crashing or forcing a failover at the application level. Therefore, the purpose of the virtual RDMA device is to remap or reroute RDMA traffic to a redundant, healthy NIC when an unhealthy NIC is detected (which was handling RDMA traffic of GPU applications).

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system, comprising:
at least one processor;
multiple network interface controllers (NICs); and
a virtual remote direct memory access (RDMA) device configured to manage data workloads between processor applications and the multiple NICs when a failure event is detected in at least one NIC of the multiple NICs.

2. The system of claim 1, wherein the at least one processor is a graphics processing unit (GPU) and the processor applications are GPU applications.

3. The system of claim 1, wherein the processor applications are unaware of the failure event detected in the at least one NIC of the multiple NICs.

4. The system of claim 1, wherein, when the failure event is an uplink failure, the virtual RDMA device rebalances data traffic to one or more functional NICs of the multiple NICs.

5. The system of claim 1, wherein, when the failure event is a soft failure or a hard failure, the virtual RDMA device redirects data traffic to one or more functional NICs of the multiple NICs.

6. The system of claim 1, wherein, when the failure event results from maintenance or upgrade downtime, the virtual RDMA device rebalances data traffic to one or more functional NICs of the multiple NICs and isolates the at least one NIC having the failure event.

7. The system of claim 1, wherein virtual queue pairs (QPs) are transmitted between the processor applications and the virtual RDMA device.

8. The system of claim 7, wherein the virtual QPs are mapped to physical resources using a RDMA driver.

9. A method comprising:
electrically connecting multiple network interface controllers (NICs) to each other within a host including at least one processor; and
using a virtual remote direct memory access (RDMA) device to manage data workloads between processor applications and the multiple NICs when a failure event is detected in at least one NIC of the multiple NICs.

10. The method of claim 9, wherein the at least one processor is a graphics processing unit (GPU) and the processor applications are GPU applications.

11. The method of claim 9, wherein the processor applications are unaware of the failure event detected in the at least one NIC of the multiple NICs.

12. The method of claim 9, wherein, when the failure event is an uplink failure, the virtual RDMA device rebalances data traffic to one or more functional NICs of the multiple NICs.

13. The method of claim 9, wherein, when the failure event is a soft failure or a hard failure, the virtual RDMA device redirects data traffic to one or more functional NICs of the multiple NICs.

14. The method of claim 9, wherein, when the failure event results from maintenance or upgrade downtime, the virtual RDMA device rebalances data traffic to one or more functional NICs of the multiple NICs and isolates the at least one NIC having the failure event.

15. The method of claim 9, wherein virtual queue pairs (QPs) are transmitted between the processor applications and the virtual RDMA device.

16. The method of claim 15, wherein the virtual QPs are mapped to physical resources using a RDMA driver.

17. A method comprising:
detecting a failure event in at least one network interface controller (NIC) of a plurality of NICs within a host including at least one processor; and
rebalancing data traffic to one or more functional NICs of the plurality of NICs using a virtual remote direct memory access (RDMA) device.

18. The method of claim 17, wherein the at least one processor is a graphics processing unit (GPU).

19. The method of claim 17, wherein processor applications of the at least one processor are unaware of the failure event detected in at least one NIC of the plurality of NICs.

20. The method of claim 19, wherein virtual queue pairs (QPs) are transmitted between the processor applications and the virtual RDMA device.
